(19) United States
(12) Patent Application Publication
(10) Pub. No.: US 2004/0070281 A1
(43) Pub. Date: Apr. 15, 2004

(54) Method and apparatus for isolating a cogeneration system from a utility source

(75) Inventor: Timothy Lee Lineberger, Mount Holly, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Carolina Tractor & Equipment Company

(21) Appl. No.: 10/271,409

(22) Filed: Oct. 15, 2002

(51) Int. Cl. H02J 1/00

(52) U.S. Cl. 307/85

(57) ABSTRACT

A cogeneration system is provided that includes at least one generator and a controller. The controller is in electrical communication with the at least one generator. The controller is structured to transmit a signal to the at least one generator to cause the at least one generator to change by a predetermined amount the frequency and/or voltage of the output power from the at least one generator to enable an interruption of the utility source to be detected so that the at least one generator can be isolated from the utility source.

### BACKGROUND OF THE INVENTION

1. Field of the Invention

This invention relates to a method and apparatus for isolating an electrical power source from a utility source and, more particularly, relates to a method and apparatus for isolating a utility-connected cogeneration system, such as a standby generator, from a utility source upon interruption of the utility source.

2. Description of Related Art

Many industrial and commercial facilities include backup power sources or cogeneration systems, such as one or more generators, to provide power to the facility in the event of a utility interruption or power outage. Under certain circumstances, these cogeneration systems may also be operated in parallel with the utility source. For example, many utility companies apportion the cost of the electricity generating equipment among the electricity users based upon each users load during peak demand periods. Thus, to reduce an electricity user's energy costs, the user may use a congeneration system to decrease the amount of utility-supplied electricity used during periods of peak demand.

During the parallel operation of a cogeneration system with the utility source, if the cogeneration system has sufficient capacity to supply the entire electrical load of the user's facility, the cogeneration system can continue to operate after an interruption of the utility source, such as a power outage, without detecting a loss of the utility source. This situation is commonly known as “islanding” of the cogeneration system and results in the cogeneration system supplying electricity not only to the facility, but to the utility power lines as well (also known as “reverse voltage” being applied to the distribution lines). Protective relays located along the power lines connecting the generator to the utility source typically require a current, voltage or frequency change outside a specified range or threshold before detecting a utility interruption. Because a cogeneration system operating in parallel with the utility source will supply electricity having the same current, voltage and frequency as the utility source, it is not uncommon for the protective relays not to detect a utility interruption. This situation can be quite dangerous to utility personnel working on utility lines being supplied by the cogeneration system, as the personnel may not be aware that the utility lines are carrying electricity.

In seeking solutions to the problems associated with islanding of cogeneration systems, others have proposed various devices for monitoring the electrical power and energy supplied by the cogeneration system and the utility source. For example, U.S. Pat. No. 4,752,697 to Lyons et al. discloses a cogeneration system and method of operation that includes computer monitoring of the electrical power and energy supplied by the cogeneration system and the utility. As taught by the Lyons '697 patent, direct monitoring of the utility data permits detection of utility faults, such as overvoltage, undervoltage, improper phase sequence, current imbalance, overfrequency, underfrequency, reverse power, and overcurrent conditions. However, the installation and maintenance of complex computer network to directly monitor utility data can be expensive.

Accordingly, there remains a need for methods and apparatus for detecting and avoiding islanding of utility-interconnected cogeneration systems. Such methods and apparatus should be relatively inexpensive to install and maintain and should be compatabile with existing cogeneration systems.

### SUMMARY OF THE INVENTION

The present invention provides a method and apparatus for detecting when an interuption in the utility source has occurred and for opening a circuit breaker between a cogeneration system, such as a generator, and the utility source to thereby isolate the cogeneration system from the distribution line of the utility source. According to one embodiment of the present invention, the apparatus includes a controller that is structured to transmit a signal to a generator to cause the generator to change by a predetermined amount the frequency or the voltage of the output power from the generator to thereby enable the detection of a utility source interruption and the isolation of the generator from the utility source due to at least one of overfrequency, overvoltage, underfrequency, or undervoltage. The controller preferably is structured to periodically transmit the signal to the generator. The controller can include a programmable logic controller or a microprocessor. The controller also can include a solid-state reference adjuster or a transistor network.

The present invention also provides a utility-interconnected cogeneration system. According to one embodiment, the cogeneration system includes at least one generator and a controller. The controller is in electrical communication with the at least one generator. The controller is structured to transmit a signal to the at least one generator to cause the at least one generator to change by a predetermined amount the frequency or voltage of the output power from the at least one generator to thereby enable the detection of a utility source interruption and the isolation of the generator from the utility source due to at least one of overfrequency, overvoltage, underfrequency, or undervoltage.

The present invention also provides a method of monitoring a utility source. According to one embodiment, the method comprises transmitting a signal from a controller to a generator to cause the generator to change by a predetermined amount at least one of the frequency and voltage of the output power from the generator. The transmitting step preferably is periodically repeated. An interruption of the utility source is then detected. In one embodiment, the interruption of the utility source is detected by sensing at least one of overvoltage or undervoltage. In another embodiment, the interruption of the utility source is detected due by sensing at least one of overfrequency or underfrequency.

The present invention also provides a method of detecting the interruption of a utility source and isolating a utility-interconnected generator. According to one embodiment, the method includes transmitting a signal from a controller to a generator to cause the generator to change by a predetermined amount at least one of the frequency and voltage of the output power from the generator. The method preferably includes periodically repeating the transmitting step. An interruption of the utility source is then detected. In one embodiment, the detecting step includes sensing with a protective relay at least one of overvoltage or undervoltage. In another embodiment, the detecting step includes sensing with a protective relay at least one of overfrequency or underfrequency. Thereafter, a circuit breaker is opened between the generator and the utility source to isolate the generator from the utility source.

Accordingly, the present invention provides methods and apparatus for detecting and avoiding islanding of utility-interconnected power sources and cogeneration systems, such as generators. The methods and apparatus are relatively inexpensive to install and maintain, particularly in comparison to coventional computer networks, and are compatabile with existing generators.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate certain exemplary embodiments and which are not necessarily drawn to scale, wherein:

FIG. 1 is a circuit diagram illustrating a cogeneration system connected to a utility source, according to one embodiment of the present invention;

FIG. 2 is a circuit diagram illustrating an apparatus for enabling the detection of an interruption of a utility source and opening of a circuit breaker to isolate a utility-interconnected cogeneration system, according to one embodiment of the present invention;

FIG. 3 is a flow chart illustrating a method for monitoring a utility source, according to one embodiment of the present invention; and

FIG. 4 is a flow chart illustrating a method of detecting the interruption of a utility source and isolating a utility-interconnected generator, according to one embodiment of the present invention.

### DETAILED DESCRIPTION OF THE INVENTION

The present invention now will be described more fully hereinafter with reference to the accompanying drawings, in which some, but not all, embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

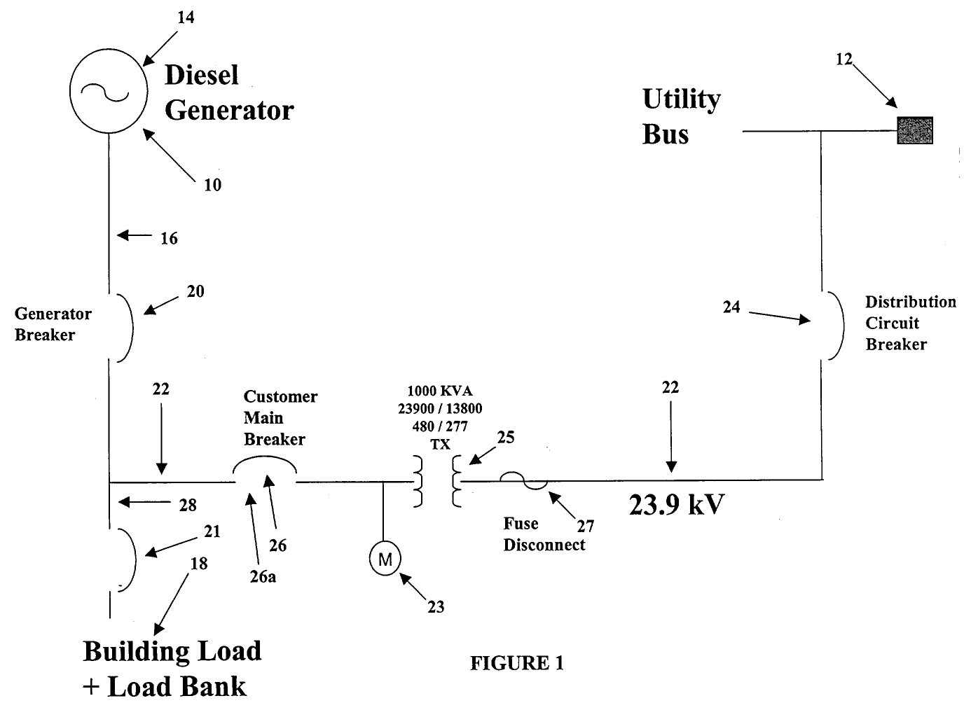

Referring to the drawings and, in particular to FIG. 1, there is provided a circuit diagram illustrating a cogeneration system 10 connected in parallel with a utility source 12, according to one embodiment of the present invention. The cogeneration system 10 can include one or more generators 14, such as a reciprocating engine or combustion turbine. The cogeneration system 10 distributes electricity via distribution lines 16 to a utility user's facility 18, which will have an electricity demand or load that will vary depending on the electricity requirements of the user. Typically, the distribution lines 16 connecting the cogeneration system 10 to the user's facility 18 will include one or more circuit breakers 20, such as electrically operated generator main breakers, as is well known to those skilled in the art. In addition, the user's facility typically will include one or more conventional customer distribution breakers 21.

The utility source 12 is connected to the user's facility 18 through corresponding distribution line or lines 22, which will generally be used to supply electricity to the user's facility and to other customers of the utility. According to the embodiment illustrated, the electricity supplied by the utility source 12 is rated at 23.9 kV; however, the rating of the electricity supplied by the utility source may vary. The distribution line 22 from the utility source 12 to the user's facility 18 typically will include one or more distribution circuit breakers 24. One or more transformers 25 also are typically provided along the distribution line 22 from the utility source 12. A utility meter 23 typically is connected to the distribution line 22 to measure the quantity of electricity being used by the user's facility 18. A fuse disconnect 27 also is typically provided to provide over current protection to the user's facility 18.

In addition to the distribution circuit breakers 24, there are typically provided one or more customer main circuit breakers 26, such as an electrically operated service entrance breaker, where the distribution line 22 from the utility source 12 connects to the electrical wiring 28 of the user's facility 18. Customer main circuit breakers 26 are typically provided with protective relays 26a that together with the generator circuit breakers 20 form a conventional switch gear. The protective relays 26a are structured to detect a current, voltage or frequency change outside a specified range or threshold, which is indicative of a utility source interruption. In the event a utility source interruption is detected by the the protective relay 26a, the protective relay is structured to open the customer main circuit breaker 26.

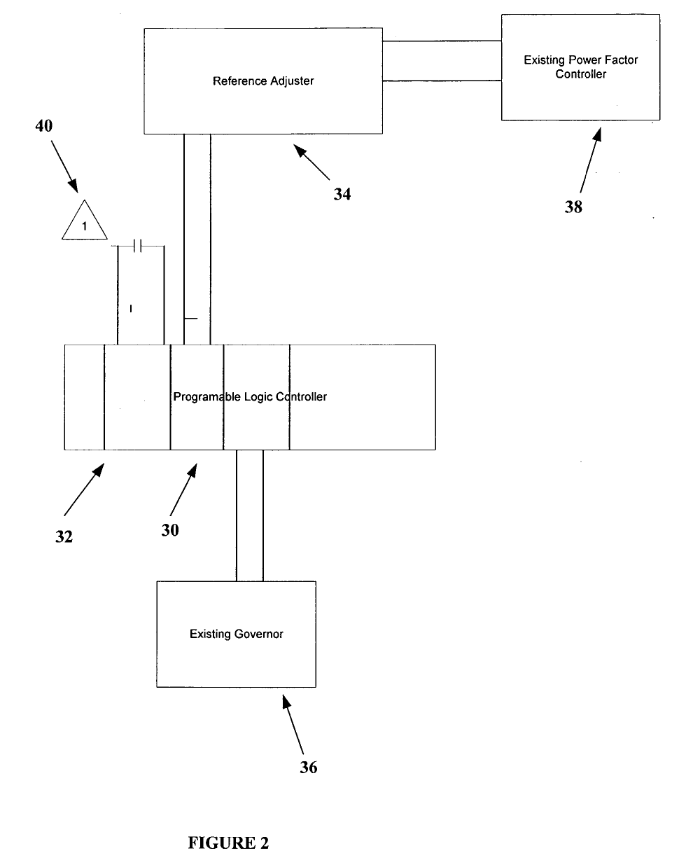

Referring to FIG. 2, there is illustrated a circuit diagram for an apparatus 29 that enables the protective relay 26a to detect an interruption of a utility source 12 so that the relay will open the customer main circuit breaker 26 to isolate a utility-interconnected cogeneration system 10, according to one embodiment of the present invention. The apparatus 29 includes a controller 30. The components and specifications of the controller 30 can vary depending on the specifications of the cogeneration system 10. In the illustrated embodiment, the controller 30 includes a programmable logic controller 32, that operates based on pre-programmed instructions, and a solid-state reference adjuster 34. The programmable logic controller 32 can include any one of the many available commercial controllers, including, but not limited to, a DirectLogic 205 Series Type 230 from Automationdirect.com of Cummings, Ga. The reference adjuster 34 can include a RA-70 from Basler Electric of Highland, Ill. In other embodiments, the controller 30 includes only a programable logic controller 32 or a microprocessor (not shown), such as a computer operating under software control, with or without the reference adjuster 34. In still other embodiments, a transistor network (not shown) can be substituted for the reference adjuster 34.

The controller 30 is in electrical communication with the governor 36 of at least one generator 14 in the cogeneration system 10 and/or the power factor controller 38 of the at least one generator. According to the illustrated embodiment, the programable logic controller 32 is in electrical communication through suitable wiring with the governor 36 of the at least one generator 14. Similarly, the programable logic controller 32 is in electrical communication through suitable wiring with the reference adjuster 34, which is in electrical communication through suitable wiring with the power factor controller 38 of the at least one generator 14. Advantageously, the controller 30 can be built integrally with the generator 14 or can be inexpensively retrofitted to existing generators.

As illustrated in FIG. 2, the contoller 30 preferably is in electrical communication with the switch gear 40, which, as noted above, typically includes the customer main circuit breakers 26, protective relays 26a and the generator circuit breakers 20. In this regard, it is preferable for the apparatus 29 not to become operative, i.e., begin transmitting signals to the governor 36 and/or the power factor controller 38 of the generator 14, until both the customer main circuit breakers 26 and the generator circuit breakers 20 have been closed. Otherwise, the apparatus 29 may impede the synchronization of the generator 14 with the electricity supplied by the utility source 12.

During operation, the controller 30 of the apparatus 29 transmits a signal to the generator 14 to cause the generator to change by a predetermined amount the frequency or the voltage of the output power from the generator. For example, the programmable logic controller 32 transmits a signal to the governor 36 of the generator 14 to change the speed of the generator thereby increasing the frequency of the output power from the generator. Alternatively or concurrently, the programmable logic controller 32 transmits a signal to the power factor controller 38 of the generator 14 to change the voltage of the output power from the generator. Preferably, since an interruption of the utility source 12 is unpredictable, the controller 30 is programmed to transmit a signal to the governor 36 and/or the power factor controller 38 of the generator 14 periodically on a preprogrammed schedule. In the event there is no interruption of the utility source 12, a change in the frequency or voltage of the output power from the generator 14 will not be sufficient to change the frequency or voltage of the electricity in the utility distribution line 22 and, thus, the protective relay 26a will not detect an interruption of the utility source 12.

In the event there is an interruption of the utility source 12, a change in the frequency or voltage of the output power from the generator 14 will be sufficient to change the frequency or voltage of the electricity in the utility distribution line 22 and, thus, cause the protective relay 26a to detect the utility source interruption. More specifically, where the controller 30 transmits a signal to governor 36 of the generator 14 to increase the speed of the generator, the protective relay 26a will sense an increase in the frequency of the electricity in the distribution line, i.e., overfrequency. Where the controller 30 transmits a signal to governor 36 of the generator 14 to decrease the speed of the generator the protective relay 26a will sense a decrease in the frequency of the electricity in the distribution line, i.e., underfrequency. Where the controller 30 transmits a signal to power factor controller 38 of the generator 14 to increase the voltage of the output power from the generator, the protective relay 26a will sense an increase in the voltage of the electricity in the distribution line, i.e., overvoltage. Where the controller 30 transmits a signal to power factor controller 38 of the generator 14 to decrease the voltage of the output power from the generator, the protective relay 26a will sense a decrease in the voltage of the electricity in the distribution line, i.e., undervoltage.

The amount of change of the frequency or voltage in the output power of the generator 14 necessary for the protective relay 26a to sense the overfrequency, underfrequency, overvoltage, or underfrequency, respectively, will depend upon the specifications of the relay. According to one embodiment, the frequency is increased to about 60.5 hertz for overfrequency and decreased to about 59.5 hertz for underfrequency. According to another embodiment, the voltage is increased to about 105% of the rated voltage for overvoltage and decreased to about 85% of the rated voltage for undervoltage. Once the interruption of the utility source 12 is detected by the protective relay 26a, the protective relay will open the corresponding customer main circuit breaker 26 thereby isolating the cogeneration system 10 from the distribution line 22. According to another embodiment of the present invention, the protective relay 26a can be adapted to open the generator circuit breaker 20 instead of, or together with, the customer main circuit breaker 26.

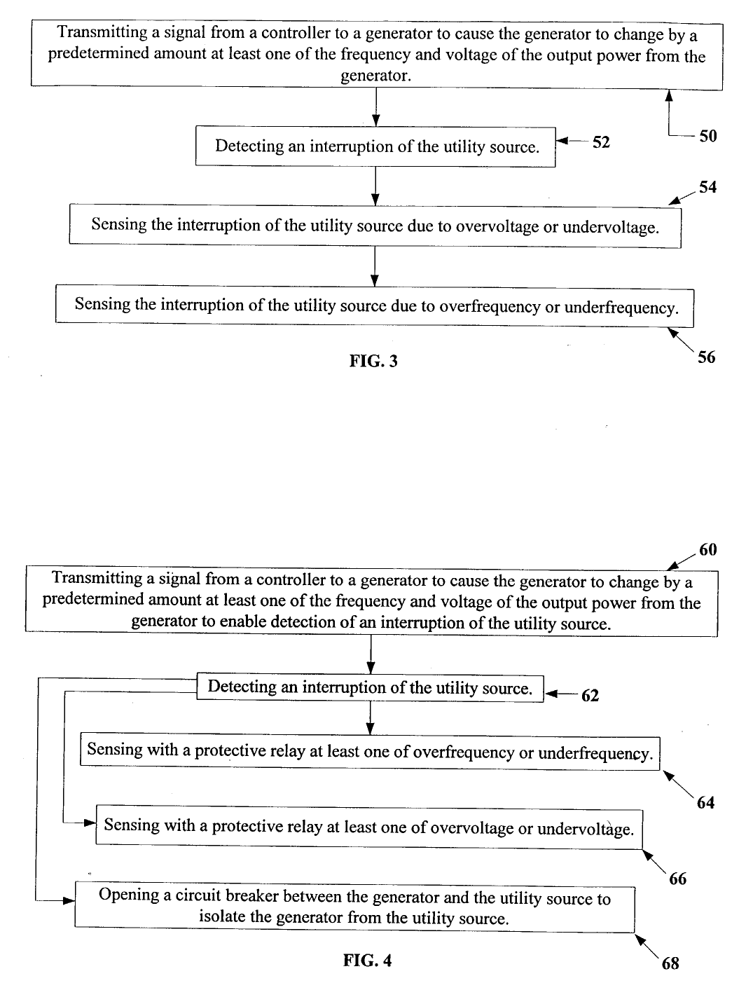

Referring to FIG. 3, there is illustrated the operations performed to monitoring a utility source, according to one embodiment of the present invention. The method comprises transmitting a signal from a controller to a generator to cause the generator to change by a predetermined amount at least one of the frequency and voltage of the output power from the generator. See Block 50. The transmitting step preferably is periodically repeated at least until an interruption in the utility source is detected. An interruption of the utility source is then detected. See Block 52. In one embodiment, the interruption of the utility source is detected by sensing at least one of overvoltage or undervoltage. See Block 54. In another embodiment, the interruption of the utility source is detected due by sensing at least one of overfrequency or underfrequency. See Block 56.

Referring to FIG. 4, there is illustrated the operations performed to detect the interruption of a utility source and isolate a utility-interconnected generator, according to one embodiment of the present invention. The method includes transmitting a signal from a controller to a generator to cause the generator to change by a predetermined amount at least one of the frequency and voltage of the output power from the generator. See Block 60. The method preferably includes periodically repeating the transmitting step at least until an interruption in the utility source is detected. An interruption of the utility source is then detected. See Block 62. In one embodiment, the interruption of the utility source is detected by sensing with a protective relay at least one of overfrequency or underfrequency. See Block 64. In another embodiment, the interruption of the utility source is detected by sensing with a protective relay at least one of overvoltage or undervoltage. See Block 66. Once an interruption of the utility source is detected, a circuit breaker between the generator and the utility source to isolate the generator from the utility source. See Block 68.

FIGS. 2, 3 and 4, are block diagrams, flowcharts and control flow illustrations of methods, systems and program products according to the invention. It will be understood that each block or step of the block diagrams, flowcharts and control flow illustrations, and combinations of blocks in the block diagrams, flowcharts and control flow illustrations, can be implemented by computer program instructions. These computer program instructions may be loaded onto a programmable logic controller, computer or other programmable apparatus to produce a machine or apparatus, such that the instructions which execute on the programmable logic controller, computer or other programmable apparatus the functions specified in the block diagrams, flowcharts or control flow block(s) or step(s). These computer program instructions may also be stored in a computer-readable memory that can direct a programmable logic controller, computer or other programmable apparatus to function in a particular manner, such that the instructions stored in the computer-readable memory produce an article of manufacture, including instruction devices which implement the functions specified in the block diagrams, flowcharts or control flow block(s) or step(s). The computer program instructions may also be loaded onto a programmable logic controller, computer or other programmable apparatus to cause a series of operational steps to be performed on the programmable logic controller, computer or other programmable apparatus to produce a computer implemented process such that the instructions which execute on the programmable logic controller, computer or other programmable apparatus provide steps for implementing the functions specified in the block diagrams, flowcharts or control flow block(s) or step(s).

Accordingly, blocks or steps of the block diagrams, flowcharts or control flow illustrations support combinations of devices for performing the specified functions, combinations of steps for performing the specified functions and program instruction devices for performing the specified functions. It will also be understood that each block or step of the block diagrams, flowcharts or control flow illustrations, and combinations of blocks or steps in the block diagrams, flowcharts or control flow illustrations, can be implemented by special purpose hardware-based computer systems which perform the specified functions or steps, or combinations of special purpose hardware and computer instructions.

Accordingly, the present invention provides methods and apparatus for detecting and avoiding islanding of utility-interconnected power sources and cogeneration systems, such as generators. The methods and apparatus are relatively inexpensive to install and maintain, particularly in comparison to coventional computer networks, and are compatabile with existing cogeneration systems. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for isolating a utility-interconnected generator from a utility source, comprising:
a controller, said controller being structured to transmit a signal to the generator to cause the generator to change by a predetermined amount at least one of the frequency and voltage of the output power from the generator to thereby enable the detection of a utility source interruption and the isolation of the generator from the utility source due to at least one of overfrequency, overvoltage, underfrequency, and undervoltage.

2. An apparatus according to claim 1 wherein said controller is structured to periodically transmit the signal to the generator.

3. An apparatus according to claim 1 wherein said controller comprises a programmable logic controller.

4. An apparatus according to claim 1 wherein said controller comprises a microprocessor.

5. An apparatus according to claim 1 wherein said controller comprises a solid-state reference adjuster.

6. An apparatus according to claim 1 where said controller comprises a transistor network.

7. A utility-interconnected cogeneration system, comprising:
at least one generator; and
a controller, said controller being in electrical communication with said at least one generator, said controller being structured to transmit a signal to said at least one generator to cause said at least one generator to change by a predetermined amount at least one of the frequency and voltage of the output power from said at least one generator to thereby enable the detection of a utility source interruption and the isolation of the generator from the utility source due to at least one of overfrequency, overvoltage, underfrequency, and undervoltage.

8. An apparatus according to claim 7 wherein said controller is structured to periodically transmit the signal to the generator.

9. An apparatus according to claim 7 wherein said controller comprises a programmable logic controller.

10. An apparatus according to claim 7 wherein said controller comprises a microprocessor.

11. An apparatus according to claim 7 wherein said controller comprises a solid-state reference adjuster.

12. An apparatus according to claim 7 where said controller comprises a transistor network.

13. A method of monitoring a utility source, comprising:
transmitting a signal from a controller to a generator to cause the generator to change by a predetermined amount at least one of the frequency and voltage of the output power from the generator; and
detecting the interruption of the utility source.

14. A method according to claim 13 further comprising periodically repeating said transmitting step.

15. A method according to claim 13 wherein said detecting step comprises sensing at least one of overvoltage and undervoltage.

16. A method according to claim 13 wherein said detecting step comprises sensing at least one of overfrequency and underfrequency.

17. A method of detecting the interruption of a utility source and isolating a utility-interconnected generator, comprising:
transmitting a signal from a controller to a generator to cause the generator to change by a predetermined amount at least one of the frequency and voltage of the output power from the generator;
detecting an interruption of the utility source; and
subsequent to said detecting step, opening a circuit breaker between the generator and the utility source to isolate the generator from the utility source.

18. A method according to claim 17 wherein said detecting step comprises sensing with a protective relay at least one of overfrequency and underfrequency.

19. A method according to claim 17 wherein said detecting step comprises sensing with a protective relay at least one of overvoltage and undervoltage.

20. A method according to claim 18 further comprising periodically repeating said transmitting step.
